(19) United States
(12) Patent Application Publication
(10) Pub. No.: US 2015/0278827 A1
(43) Pub. Date: Oct. 1, 2015

(54) Virtual Marking and Verification Platform

(71) Applicant: 5DE, LLC, Atlanta, GA (US)

(72) Inventors: Mikhail Avady, Atlanta, GA (US); Raymond Marceau, Atlanta, GA (US); Liza Kukuliyeva, Atlanta, GA (US); Yuri Eliezer, Atlanta, GA (US); Andrei Tsygankov, Atlanta, GA (US); Jarryd McCree, Atlanta, GA (US)

(21) Appl. No.: 14/674,862

(22) Filed: Mar. 31, 2015

Related U.S. Application Data
(60) Provisional application No. 61/973,532, filed on Apr. 1, 2014.

(51) Int. Cl. G06Q 30/00; G06Q 50/18

(52) U.S. Cl. CPC G06Q 30/018; G06Q 50/184

(57) ABSTRACT

Embodiments of the present disclosure may provide a Virtual Marking and Verification Platform (hereinafter referred to as the “platform”). The platform may be used by holders of intellectual property (IP) rights to put the public on notice of their rights. To put the public on notice, users of the platform (e.g., the IP rights holders) may register to receive a seal issued by the platform. The seal may be comprised of a combination of graphical and/or textual elements confined in, for example, a computer-icon. The computer-icon may be associated with a uniform resource locator (URL) that leads to a certificate page. The certificate page may comprise information associated with the user's intellectual property rights. A user may display an issued seal within the user's software application and/or website. Viewers of the seal may then ‘click’ the seal to view the certificate page containing information associated with the user's intellectual property rights. In this way, the user may have ‘virtually marked’ his software and/or website and a viewer may have been placed on ‘notice’ of the user's IP rights.

### RELATED APPLICATION

Under provisions of 35 U.S.C. §119(e), the Applicant claim the benefit of U.S. provisional application No. 61/973,532, filed on Apr. 1, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### BACKGROUND

Under 35 U.S.C. §287, a patent owner can only collected damages from a patent infringer if adequate notice is given of the patent(s) to the infringer. This is known as the patent marking and notice requirement. Failure to comply with the patent marking and notice requirement of US Patent law can be a costly oversight for patent owners. Adequate notice may come in two forms “constructive notice” and “actual notice”.

Actual notice occurs when an alleged infringer is notified by the patent holder that the infringer's products infringe on the patent held by the owner. Constructive notice is occurs when the products are physically labeled with a patent number corresponding to the product. Thus, physical products may be marked with corresponding patent Numbers that have been granted on the product. But what if your product is a virtual product such as, for instance, a computer software, a web-app, a mobile app, or something similar?

In response to these questions, recent updates to US Patent Law permit a patentee to put the public on constructive notice via “virtual marking.” A virtual marking may comprise a web-page listing a company's products and their corresponding patents associated with those products. The web-page must be accessible to a user of those products.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates one embodiment of a landing page of the virtual marking and verification platform;

FIGS. 2A-2B illustrate embodiments of an input page of the virtual marking and verification platform;

FIGS. 3A-3B illustrate embodiments of an additional input page of the virtual marking and verification platform;

FIG. 4 illustrates one embodiment of yet an additional input page of the virtual marking and verification platform;

FIG. 5 illustrates one embodiment of a portfolio page of the virtual marking and verification platform;

FIG. 6 illustrates one embodiment of a seal overview page of the virtual marking and verification platform;

FIG. 7 illustrates one embodiment of a certificate page of the virtual marking and verification platform;

FIG. 8 illustrates one embodiment of an admin dashboard page of the virtual marking and verification platform;

FIG. 9 illustrates one embodiment of a seal editing page of the virtual marking and verification platform;

FIG. 10 illustrates another embodiment of a certificate page of the virtual marking and verification platform;

FIG. 11 illustrates yet another embodiment of a certificate page of the virtual marking and verification platform; and

FIG. 12 is a block diagram of a system including a computing device for providing the virtual marking and verification platform.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may provide a Virtual Marking and Verification Platform (hereinafter referred to as the “platform”). The platform may be used by holders of intellectual property (IP) rights to put the public on notice of their rights. To put the public on notice, users of the platform (e.g., the IP rights holders) may register to receive a seal (may also be referred to herein as a “virtual mark”) issued by the platform. The seal may be comprised of a combination of graphical and/or textual elements confined in, for example, a computer-icon. The computer-icon may be associated with a uniform resource locator (URL) that leads to a certificate page (may also be referred to herein as a “verification page”). The certificate page may comprise information associated with the user's intellectual property rights. A user may display an issued seal within the user's software application and/or website. Viewers of the seal may then ‘click’ the seal to view the certificate page containing information associated with the user's intellectual property rights. In this way, the user may have ‘virtually marked’ his software and/or website and a viewer may have been placed on ‘notice’ of the user's IP rights.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

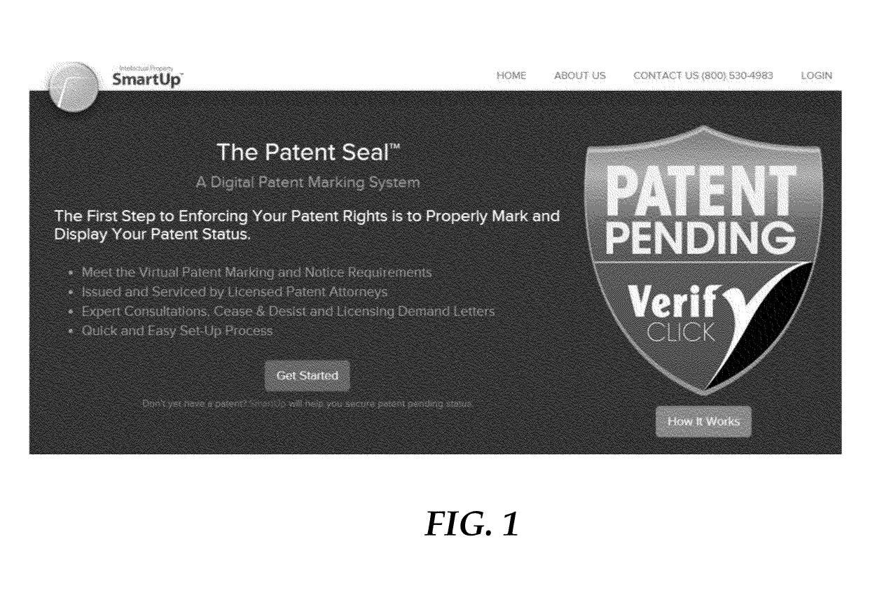

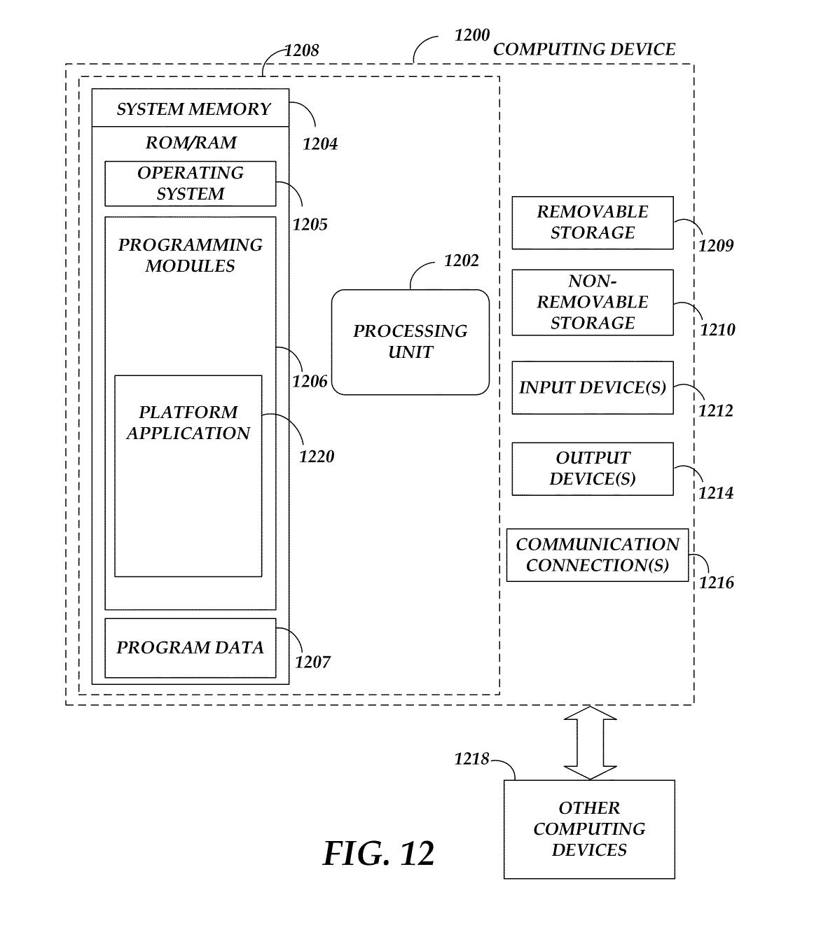

Consistent with embodiments of the present disclosure, the platform may be hosted and operated through, at least in part, a computing device residing in a cloud-computing environment. The computing device may be, for example, computing device 1200 (as illustrated by FIG. 12), which may accessible over the internet. In this way, a user may access the platform via a website. FIG. 1 illustrates one embodiment of a landing page that may be provided to a user upon his initial access to the website.

From the website, the platform may enable the user to submit a request to receive an issued seal. To submit the request the user may click a link such as, for example, the “Get Started” button on the landing page. From there, the platform may prompt the user with a serious of questions. The user's answers of these questions may be submitted through the platform and submitted to a platform administrator with the request.

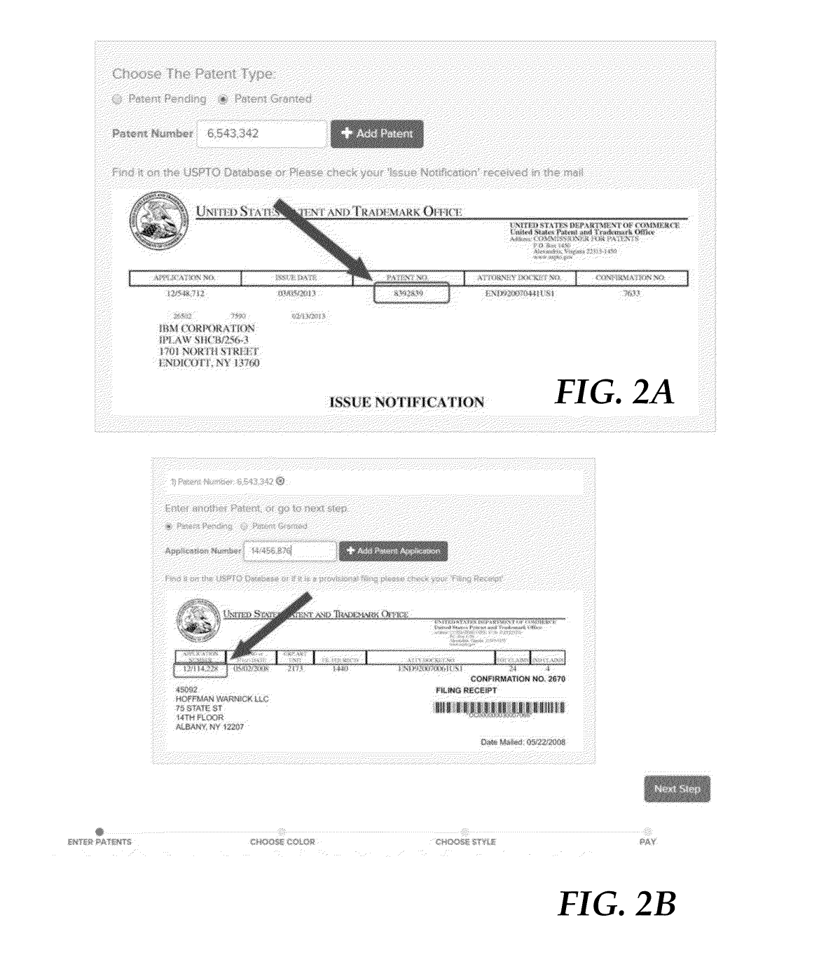

For example, as illustrated in FIG. 2, the platform may ask the user to identify which IP rights he seeks to be associated with the seal. Although the platform may be used in conjunction with any type of intellectual property (e.g., a patent, patent pending, trademark, trademark pending, and copyright owned by the user), FIGS. 2A-2B show embodiments where the user may be prompted to select from a pending or granted patent to be associated with the a requested seal.

Upon the user's selection of the IP type, the user may be prompted to provide, for example, a means to identify the IP sought to be associated with the requested seal. In some embodiments, the user may be prompted to provide, for example, an application, publication, or registration number, a title, an applicant name, an inventor name, or any other information that can be used to identify the IP. The platform may display helpful information in the form of text and/or graphics to assist the user in locating the requested information.

FIG. 2A illustrates an embodiment where a user may seek to associate a granted patent with a requested seal. The user may select “Patent Granted” as the type of intellectual property, and input the issued patent number associated with his granted patent. The user may click the “ADD PATENT” button to input the patent number into the platform. Then, the user may proceed the next stage of submitting a patent request by clicking the “Next Step” button.

Still consistent with embodiments of the present disclosure, the platform may be enabled to associate a single seal with multiple IP rights. For example, and as will be detailed below, a single seal may lead to a certificate that provides information associated with various different patents, patent applications, trademarks, and/or trademark applications. In these embodiments, the user may be enabled to input more than single IP type to be associated with the requested seal.

FIG. 2B illustrates an embodiment where the user may input at least one additional IP type. As shown, the user may have already inputted a granted patent to be associated with the requested seal. After receiving the information identifying the granted patent, the platform may subsequently enable the user to enter additional information identifying additional IP rights.

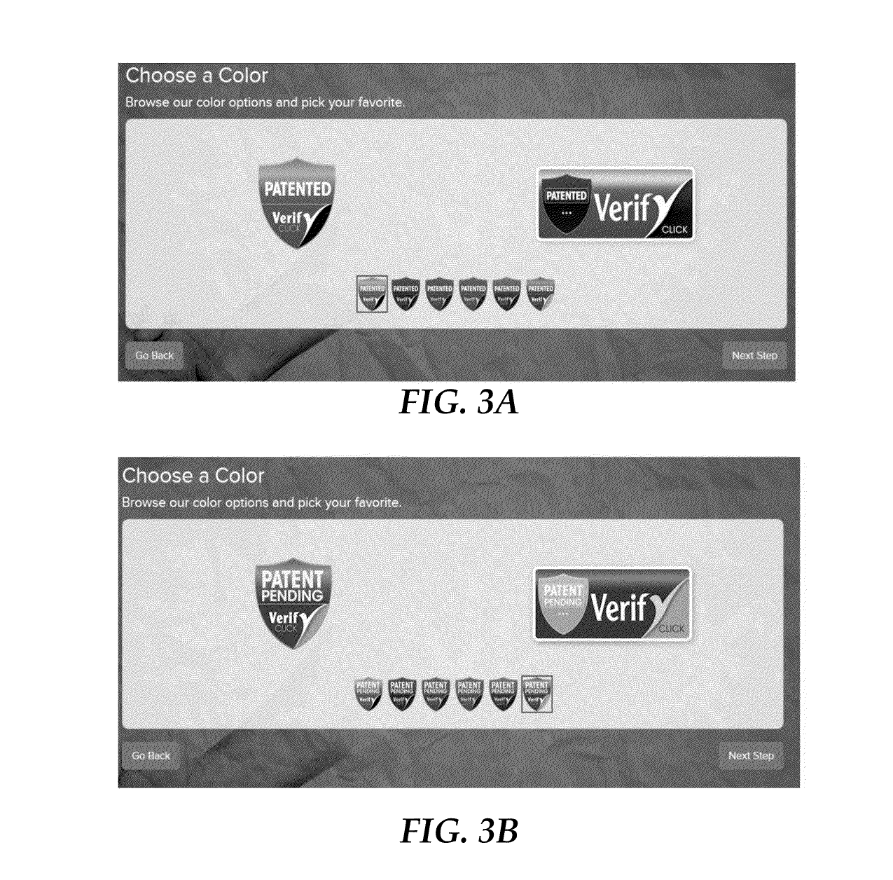

FIGS. 3A-3B illustrate various embodiments of the seal. The seal may reflect the nature of the IP rights associated with the seal. The seal may comprise text and/or graphics that reflect the IP rights of a user to whom the seal is issued. For example, as shown in FIG. 3A, the seal may be designed to indicate that the user has a granted patent. Alternatively, as shown in FIG. 3B, the seal may be designed to indicate that the user has a patent pending. In embodiments where the user is requesting a seal that may be associated with various IP types, the platform may provide a seal to reflect only a single IP type. For example, if the user is requesting a seal to reflect both patents and Pending patent application, the platform may provide the seal for the patent. However, the seal would still lead to a certificate showing the various IP rights held by the user. In other embodiments, the platform may issue separate seals for separate IP rights.

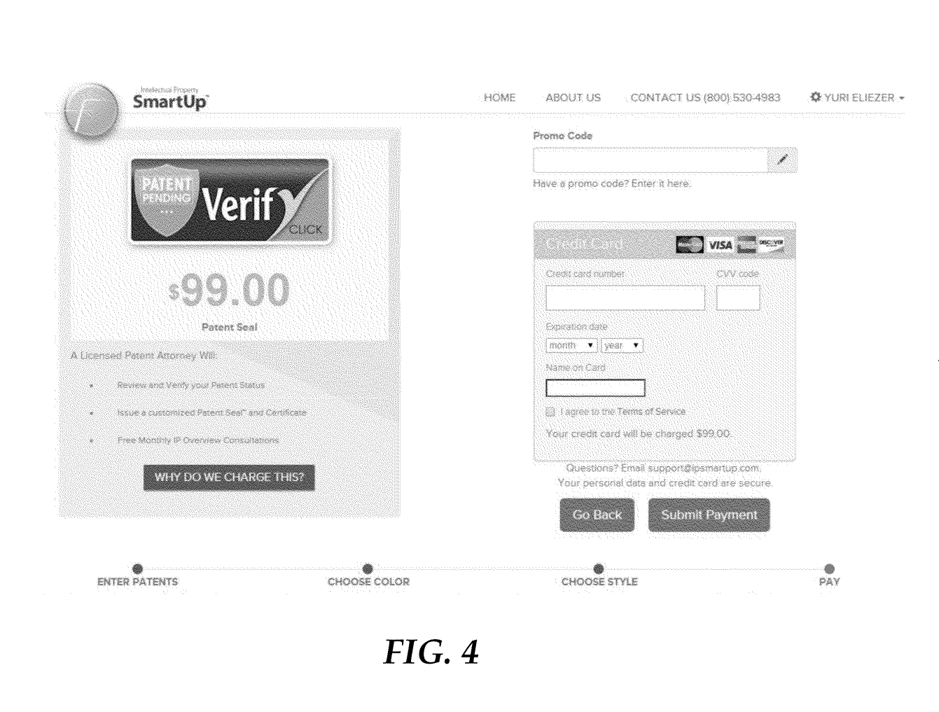

During the submission of a seal request, the platform may enable the user to select the color of the requested seal, as well as the design of the seal (i.e., banner v. shield design). Upon receipt of the user's IP information, color, and design selections, the platform may be enabled to present the user with a payment screen to pay for the seal. One embodiment of the payment screen that may be provided by the platform is presented in FIG. 4.

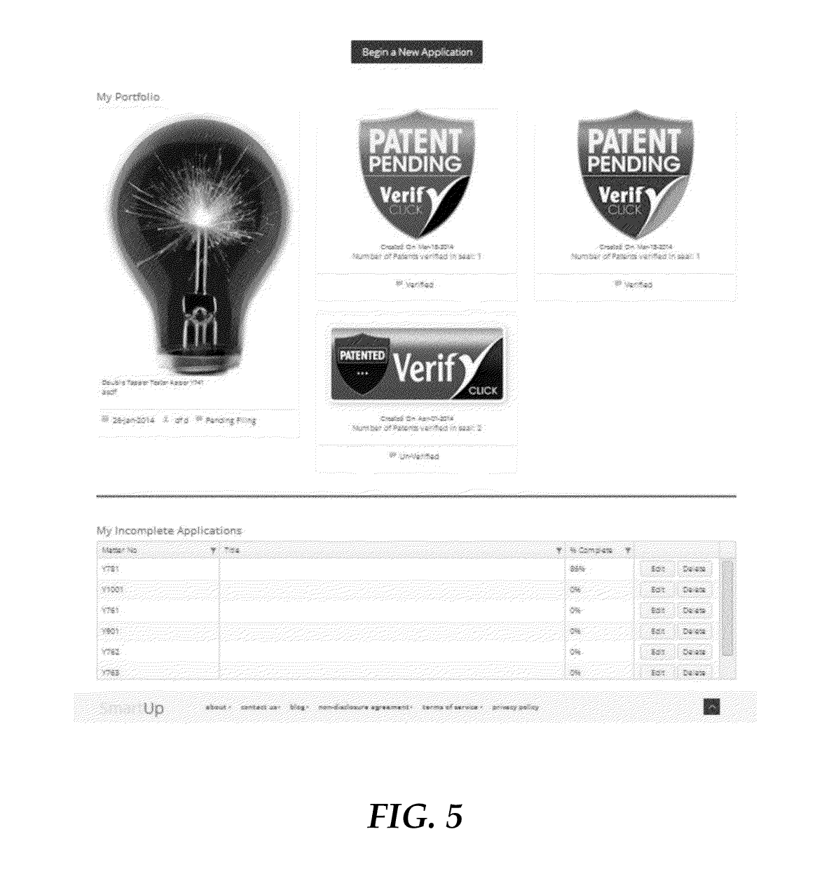

Upon submission of the request, the user may receive a confirmation email. The platform may then route the user to a Portfolio Overview page where he may view his pending requests. One embodiment of the Portfolio Overview that may be provided by the platform is illustrated in FIG. 5. The Portfolio Overview may display a plurality of the user's requested or issued seals. The display of each of the requested or issued seals in the Portfolio Overview page may comprise a graphical icon associated with the customized seal along with a textual element providing information associated with the seal. The page may further comprise a “Begin New Application” button that allows the user to submit a new request for a patent seal. Further still, the page may include an incomplete applications portion showing the various requests the user may have initiated, but not completed.

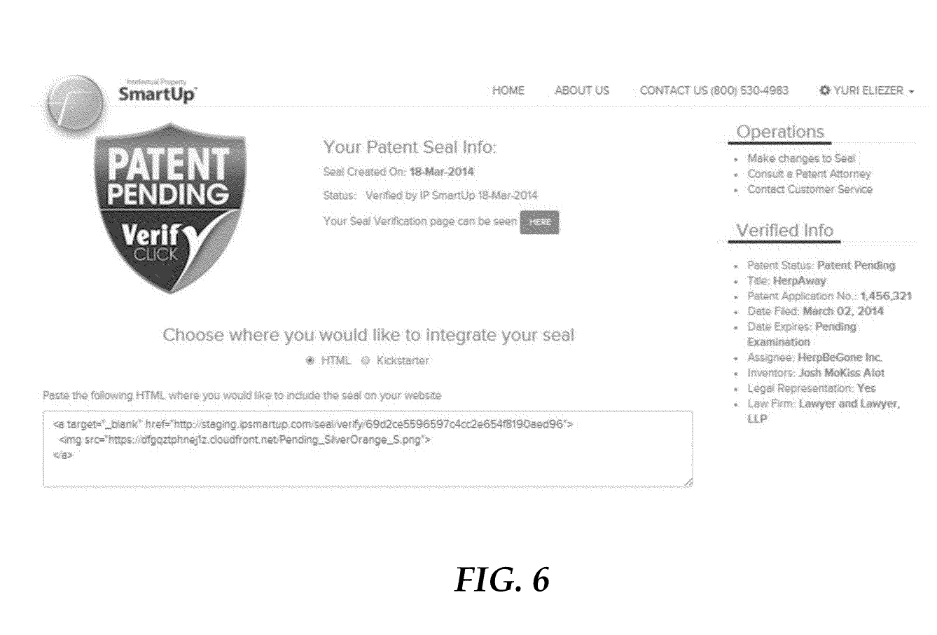

When the user clicks a graphical icon, he may be directed to a seal overview page. In some embodiments, the user may be directed to the seal overview page upon submission of the seal request. One embodiment of a seal overview page that may be provided by the platform is illustrated in FIG. 6. The seal overview page will be discussed in more detail below.

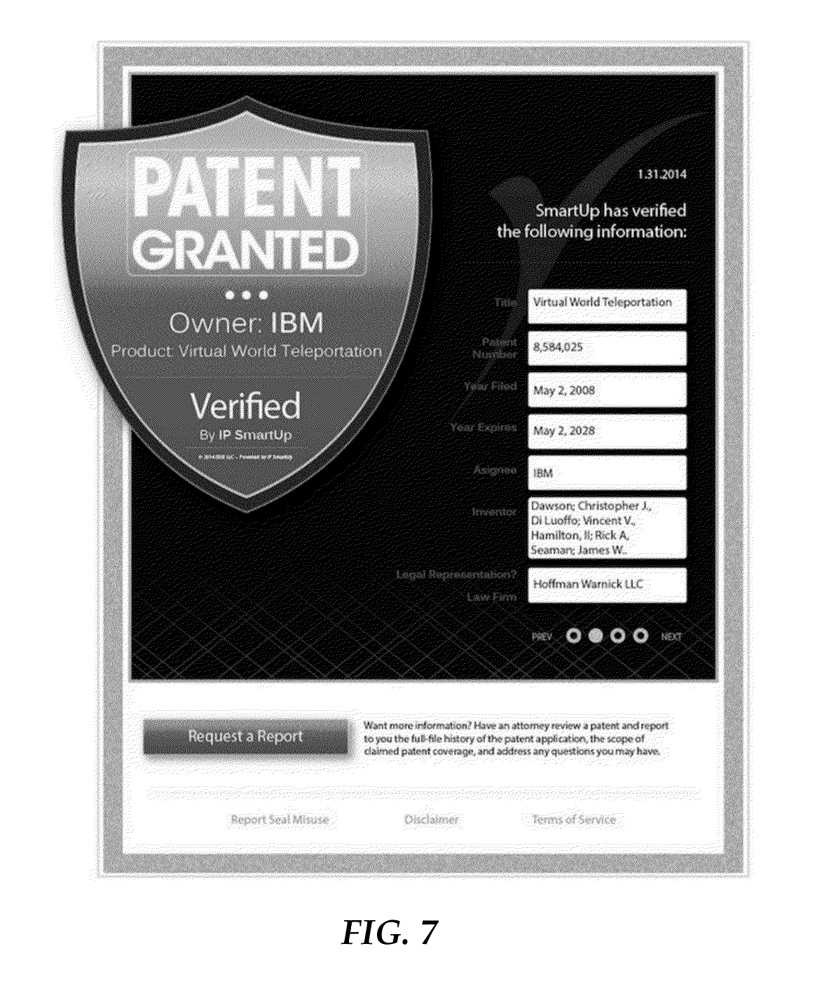

Upon receipt of a seal request, the platform may begin the process of issuing a certificate to be associated with the seal. A certificate associated with the seal may be provided to a user upon a verification of, for example, a patent, patent pending, trademark, trademark pending, and copyright submitted by the user with the seal request. The verification may be performed by an administrator of the platform, or an automated process performed by the platform. FIG. 7 illustrates one embodiment of a certificate that may be provided by the platform. The certificate may display information associated with the IP rights held by the user. The certificate may further enable viewers to scroll through the information when there are multiple IP rights represented by the certificate. Further still, the certificate may enable viewers to request a report on the IP rights of the holder.

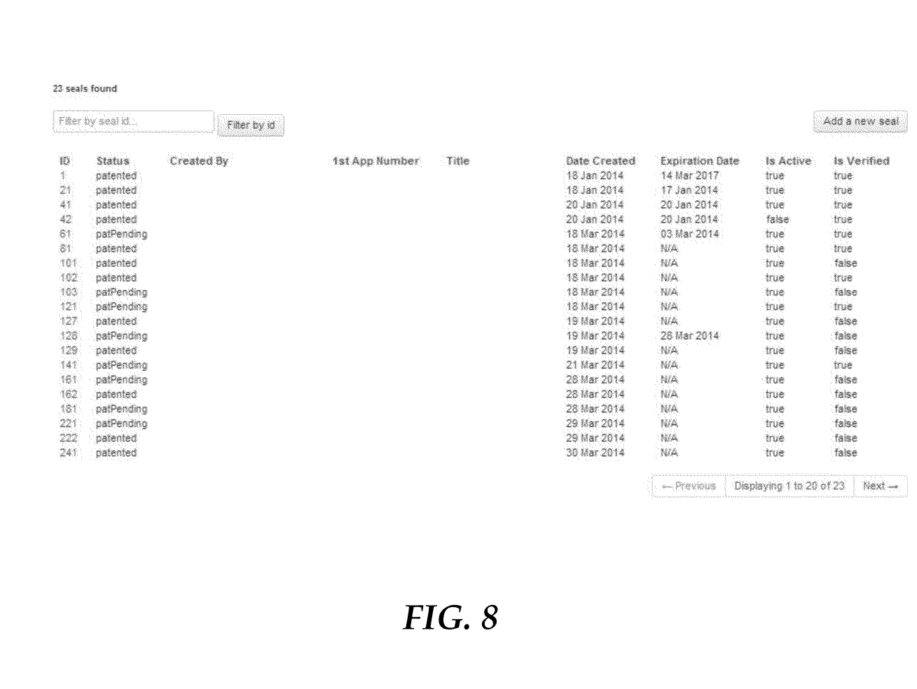

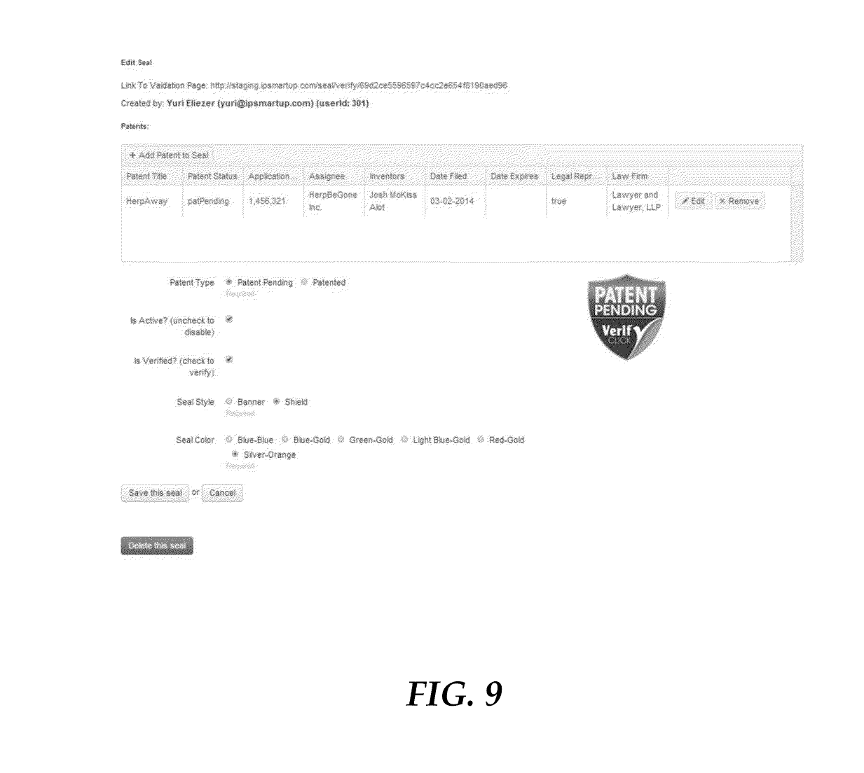

An administrator of the platform may access the platform through, for example, an admin portal. Upon entrance to the portal, the administrator may be provided with an Admin Dashboard. FIG. 8 illustrates one embodiment of an Admin Dashboard that may be provided by the platform. The Admin Dashboard may list a plurality of requested or issued seals. The administrator may add a new seal, or select one of the seals for editing, and be routed to a seal editing page of the platform. FIG. 9 illustrates one embodiment of a seal editing page.

From the seal editing page, the administrator may be provided with information on a requestor (i.e., the user of the platform), as well as other information inputted by the requestor with his seal request. Using the information provided by the requestor (e.g., patent application number or patent number), the platform may retrieve additional details associated with the Intellectual Property rights held by the requestor from, for example, the United States Patent and Trademark Office's Patent, Patent Publication, Trademark, or Trademark Publication Databases. The information may comprise, but not be limited to, for example, a patent or patent application's title, inventor listing, assignee, issuance date, expiration date, legal representative, at least one product associated with the patent or patent application, a URL to a location displaying additional information associated with the patent or patent application, and any other publically available information. Similar information may be provided for a copyright, trademark or trademark application.

In various other embodiments, the seal editing page may enable the administrator to input the information manually. In turn, this information may be displayed on a certificate associated with the seal. The administrator may further be enabled to add/remove and/or otherwise modify the IP types associated with the seal. The administrator may be enabled to customize the type of seal (e.g., color and style). Once the administrator has verified and inputted in the information to be provided on the certificate, the administrator may ‘activate’ and ‘verify’ the seal through the platform. In order to review the inputted information, the administrator may be provided with a link to the certificate page that will display the verified information. Alternatively, the platform may automatically ‘verify’ the seal upon the automated retrieval of corresponding IP information.

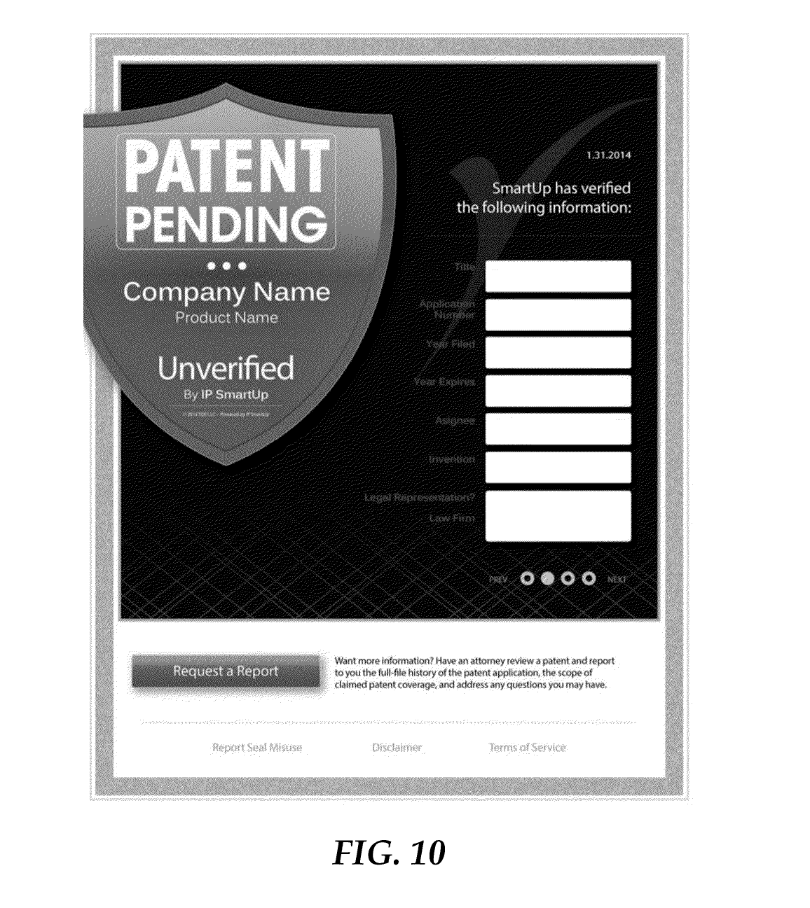

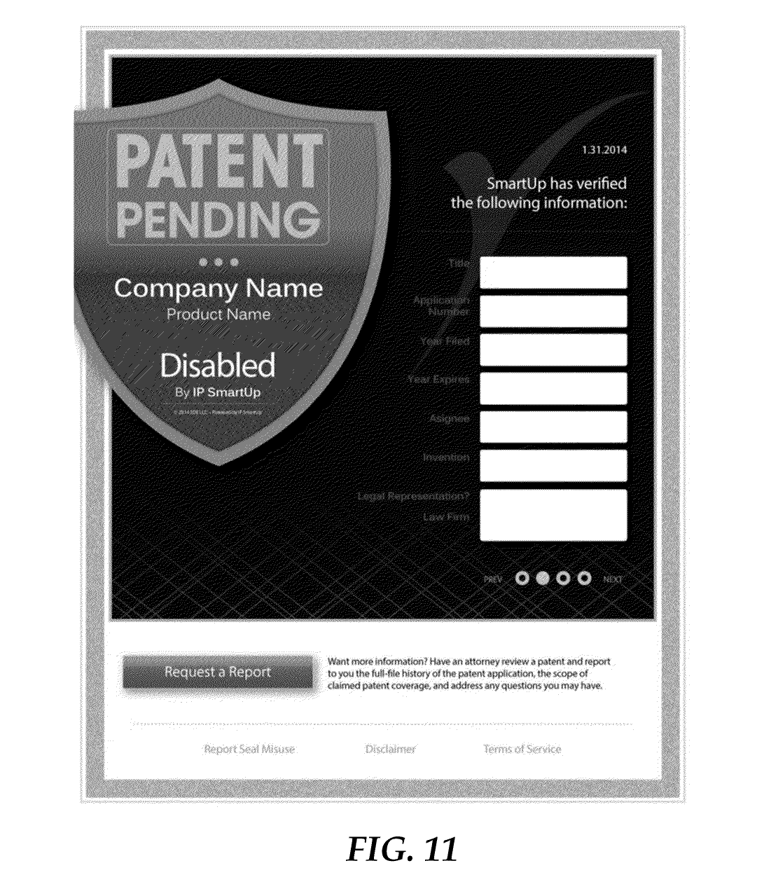

By default, the requested seal may be ‘active’ but ‘unverified’. This may mean, that the seal may be active (i.e., a clickable URL leading to a certificate page), but the certificate of the that is provided for an ‘active’ but ‘unverified’ seal indicates to viewers that the IP information associated with the seal has not yet been verified by the platform. FIG. 10 illustrates one embodiment of an active but unverified certificate. Once the administrator verifies the seal, he may indicate through the edit page that the seal has now be verified, and the platform will update the certificate to reflect the verified information (e.g., a similar certificate to the embodiment illustrated in FIG. 7). An administrator may further disable a seal. The administrator may disable the seal when, for example, the IP associated with the seal has expired. FIG. 11 illustrates one embodiment of a disabled seal.

Referring back to FIG. 6, once the platform has verified the information associated with the seal, the verified information may be populated on the user's seal overview page. The user may be provided with a link to the certificate to view the verified information that is to be displayed on the certificate.

Consistent with embodiments of the disclosure, the platform may provide the user with an ability to publish the seal on, for example, a website or software application. The certificate may be provided to the user in the form of, for example, a source-code snippet that may be inserted into a website. The user's seal overview page may comprise step-by-step instructions for inserting the source-code snippet into a website or, for example, a Kickstarter™ campaign or software application (hereinafter collectively referred to as “website”).

Once inserted into the website, the seal may be displayed on the website when a viewer loads the website. As mentioned above, the seal may be associated with a uniform resource locator (URL) such that users of the website may click (or otherwise select) the seal to be directed to the destination associated with the URL. At the destination, the certificate page may be loaded in the same window as the website, or in a separate window.

Information associated with the intellectual property verified by the digital certificate (i.e., one embodiment of which is shown in FIG. 7) may be displayed to the user once directed to the destination. However, if the information is not yet verified, or a seal is disabled, the viewer may be presented with an unverified or a disabled certificate, respectively (i.e., some embodiments of which is shown in FIGS. 10 and 11, respectively). In this way, a user of the platform may be enabled to install the seal onto the website while the platform is undergoing the process of verifying his seal.

### III. PLATFORM OPERATION

The methods and operations disclosed below may be performed by computing device 1200. It should be understood that, in some embodiments, different operations and methods described below may be performed by different networked elements in operative communication with computing device 1200. Although these operations may be disclosed in a particular order, it should be understood that the order is disclosed for illustrative purposes only. Stages may be combined, separated, reordered, and various intermediary stages may exist. Moreover, various stages may be added or removed without altering or deterring from the fundamental scope of the depicted methods and systems disclosed herein.

First, data associated (e.g., application numbers, registration numbers, inventors, owners, attorneys, and the like) with intellectual property rights (e.g., patent applications, issued patents, trademark applications, registered trademarks, and the like) may be received. Next, a selection of a virtual mark may be received. In some embodiments, the selection may be automatically made based on the data associated with the intellectual property rights (e.g., patent-pending mark? Patent-granted mark? ™ pending? ™ registered?).

Then, a snippet of code may be generated along with a verification page (in any order). The snippet of code may be configured to be placed into an electronic page (e.g., website, mobile application, desktop application, web application, PDF, word document, and other electronic documents). The snippet of code may comprise a unique uniform-resource-locator (URL) that may be associated with the verification page. When the snippet of code is inserted into the electronic page, it may cause a display of the virtual mark on the electronic page as a selectable link to the URL when the page is loaded.

The snippet of code may be provided to a user for manual placement onto the electronic page. In some embodiments, the snippet of code into the electronic page may be placed onto the electronic page automatically.

A status of the intellectual property rights may then be verified. The verification may be performed manually and inputted into the platform. In some embodiments, the verification may be performed by an automated access to an intellectual property database (e.g., the United States Patent and Trademark Office and/or the World Intellectual Property Organization). In response to the verification, the verification page may be updated to indicate the status (e.g., pending, granted, “good standing,” abandoned, expired, “bad standing,” etc.) associated with the intellectual property rights. Verification may be performed regularly and the verification page may be updated to reflect the status of the intellectual property rights.

### IV. PLATFORM ARCHITECTURE

The various platform embodiments disclosed herein may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform may be hosted on a centralized server, such as, for example, a cloud computing service. Although methods have been described to be performed by a computing device 1200, it should be understood that, in some embodiments, different operations may be performed by different networked elements in operative communication with computing device 1200.

Embodiments of the present disclosure may comprise a system having a memory storage and a processing unit. The processing unit coupled to the memory storage, wherein the processing unit is configured to perform the stages of the aforementioned methods.

FIG. 12 is a block diagram of a system including computing device 1200. Consistent with an embodiment of the disclosure, the aforementioned memory storage and processing unit may be implemented in a computing device, such as computing device 1200 of FIG. 12. Any suitable combination of hardware, software, or firmware may be used to implement the memory storage and processing unit. For example, the memory storage and processing unit may be implemented with computing device 1200 or any of other computing devices 1218, in combination with computing device 1200. The aforementioned system, device, and processors are examples and other systems, devices, and processors may comprise the aforementioned memory storage and processing unit, consistent with embodiments of the disclosure.

With reference to FIG. 12, a system consistent with an embodiment of the disclosure may include a computing device, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include application 1220. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and nonvolatile, removable and non-removable media implemented in any method or technology for storage of information, such as computer readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more of methods as described above. The aforementioned process is an example, and processing unit 1202 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving data associated with intellectual property rights;
receiving a selection of a virtual mark; and
generating a snippet of code configured to be placed into an electronic page, the snippet of code:
comprising a unique uniform-resource-locator (URL), and
being configured to cause a display of the virtual mark on the electronic page as a selectable link to the URL.

2. The method of claim 1, providing the generated snippet of code.

3. The method of claim 1, inserting the snippet of code into the electronic page.

4. The method of claim 1, further comprising generating a verification page associated with the URL, the verification page being configured to display an indication of a status associated with the intellectual property rights.

5. The method of claim 4, further comprising receiving an update to the status associated with the intellectual property rights, the updated status being dynamically indicated on the verification page.

6. The method of claim 1, further comprising receiving an indication that the intellectual property rights are in good standing.

7. The method of claim 6, further comprising, in response to the indication that the user's intellectual property rights are in good standing, generating a verification page, the verification page providing an indicating of a status associated with the intellectual property rights.

8. The method of claim 1, further comprising receiving an indication that the intellectual property rights are not in good standing.

9. The method of claim 8, further comprising, in response to the indication that the user's intellectual property rights are in good standing, generating a verification page, the verification page providing an indication of a status associated with the intellectual property rights.

10. The method of claim 4, further comprising providing the verification page in response to receiving a request for the verification page.

11. The method of claim 10, wherein the receiving the request for the verification page comprises receiving an indication of a selection of the virtual mark.

12. A computer-readable medium comprising a set of instructions which when executed perform a method comprising:
receiving data associated with intellectual property rights;
generate a virtual mark corresponding to the data associated with the intellectual property rights;
generating a verification page, the verification page being configured to display an indication of a status associated with the intellectual property rights; and
generating a snippet of code configured to be placed into an electronic page accessible via a telecommunications network, the snippet of code:
comprising a unique uniform-resource-locator (URL) corresponding to the verification page, and
being configured to cause a display of the virtual mark on the electronic page as a selectable link to the URL.

13. The computer-readable medium of claim 12, providing the generated snippet of code.

14. The computer-readable medium of claim 12, inserting the snippet of code into the electronic page.

15. The computer-readable medium of claim 12, further comprising verifying a status of the intellectual property rights.

16. The computer-readable medium of claim 15, further comprising, in response to the verification, updating the verification page to indicate the status associated with the intellectual property rights.

17. The computer-readable medium of claim 12, further comprising providing the verification page in response to receiving a request for the verification page.

18. The computer-readable medium of claim 17, wherein the receiving the request for the verification page comprises receiving an indication of a selection of the virtual mark.

19. A system comprising:
a memory storage; and
a processing unit coupled to the memory storage, wherein the processing unit is configured to:
receive data associated with at least one of the following: at least one issued patent and at least one patent application;
generate a virtual mark corresponding at least one of the following: the at least one issued patent and the at least one patent application;
generate a verification page, the verification page being configured to display an indication of a status associated with at least one of the following: the at least one issued patent and the at least one patent application; and
generate a snippet of code configured to be placed into an web page accessible via a telecommunications network, the snippet of code:
comprising a unique uniform-resource-locator (URL) corresponding to the verification page, and
being configured to cause a display of the virtual mark on the web page as a selectable link to the URL.

20. The system of claim 19, wherein the processing unit is further configured to perform at least one of the following:
provide the generated snippet of code, and
insert the snippet of code into the electronic page.
